(19) United States
(12) Patent Application Publication
(10) Pub. No.: US 2016/0154573 A1
(43) Pub. Date: Jun. 2, 2016

(54) SCREEN DISPLAY PROGRAM

(71) Applicant: NOMURA RESEARCH INSTITUTE, LTD., Tokyo (JP)

(72) Inventors: Hitoshi YANO, Tokyo (JP); Koji NAKAJIMA, Tokyo (JP); Koji TERADA, Tokyo (JP)

(73) Assignee: NOMURA RESEARCH INSTITUTE, LTD., Tokyo (JP)

(21) Appl. No.: 15/013,332

(22) Filed: Feb. 2, 2016

Related U.S. Application Data
(63) Continuation of application No. PCT/JP2013/071145, filed on Aug. 5, 2013.

(51) Int. Cl. G06F 3/0484; G06F 3/0488

(52) U.S. Cl. CPC G06F 3/04845; G06F 3/04842; G06F 3/04883; G06F 3/04886

(57) ABSTRACT

A screen display program causes a mobile terminal to execute an initial screen display procedure that includes displaying a first screen including a first item displayed in a first display mode, an input screen display procedure that includes displaying a second screen configured to receive an input of a value of the first item when the first item is selected on the first screen, and an initial screen update procedure that includes displaying an updated first screen including the first item displayed in a second display mode along with the value of the first item when the value of the first item is input on the second screen.

### CROSS-REFERENCE TO RELATED APPLICATIONS

This application is a continuation application, filed under 35 U.S.C. §111(a), of International Application PCT/JP2013/071145 filed on Aug. 5, 2013, the disclosure of which is incorporated herein by reference.

### BACKGROUND

The popularization of mobile terminals such as smartphones increases opportunities to use a variety of services, such as an Internet banking system from mobile terminals (e.g., JP 2012-247927 A). For example, a user can make a transfer to a transfer destination by logging in to an Internet banking system from a mobile terminal, selecting the transfer destination on a screen, and entering a transfer amount.

FIGS. 7A through FIG. 7C illustrate an example of screen transitions when a transfer is made in a general Internet banking system. FIG. 7A is a diagram illustrating an example of a transfer top screen. In FIG. 7A, when a “Financial institution: Tap to select” area 700 is tapped, a transition to a screen in FIG. 7B is made. FIG. 7B is a diagram illustrating an example of a screen for selecting a financial institution of a transfer account. In FIG. 7B, financial institutions selected as transfer destinations in the past are displayed. From among these financial institutions, when an area 710 with a financial institution (e.g., “ABC bank”) of this transfer account displayed therein is selected (tapped), the screen returns to the transfer top screen. FIG. 7C is a diagram illustrating an example of the transfer top screen after the selection of the financial institution. As illustrated in FIG. 7C, the financial institution (e.g., “ABC bank”) selected on the screen of FIG. 7B is displayed in the “Financial Institution” field 700 of the transfer destination.

Thus, a transfer can be made by selecting a transfer destination on a screen, entering a transfer amount, and the like. In the meantime, on the screen of FIG. 7C after the financial institution of the transfer account is selected, the display area 700 for selection of a transfer account is displayed in the upper part of the screen. Thus, in the screen control for mobile terminals, a display area related to information selected on the previous screen may be displayed in the upper part of the screen. This is to display the information efficiently in a limited screen size compared, for example, with personal computers.

However, when such a screen transition is made, a user who is performing an operation may be confused about where the user has operated. Specifically, the display area 700 for the selection of a transfer account is displayed in the middle of the screen of FIG. 7A, whereas the display area 700 for the selection of a transfer account is displayed in the upper part of the screen of FIG. 7C after the financial institution is selected in FIG. 7B. Thus, since the position of the display area 700 for the selection of a transfer account is changed before and after the selection of a financial institution, the user may lose the place where the user has operated.

### SUMMARY

Various embodiments described herein have been made in view of the circumstances discussed above, and it is an object thereof to make it easy for a user to find a place where the user has operated.

A screen display program according to various embodiments described herein causes a mobile terminal to execute an initial screen display procedure that includes displaying a first screen including a first item displayed in a first display mode, an input screen display procedure that includes displaying a second screen configured to receive an input of a value of the first item when the first item is selected on the first screen, and an initial screen update procedure that includes displaying an updated first screen including the first item displayed in a second display mode along with the value of the first item when the value of the first item is input on the second screen.

A method according to various embodiments described herein is performed in a mobile terminal with a touch screen display and includes displaying a first screen including a first item displayed in a first display mode, displaying a second screen configured to receive an input of a value of the first item when the first item is selected on the first screen, and displaying an updated first screen including the first item displayed in a second display mode along with the value of the first item when the value of the first item is input on the second screen.

According to various embodiments described herein, the term “block” does not merely relate to a physical device, but also includes a case where the function of the “block” is implemented by software. Further, the function of one “block” or device may be implemented by two or more physical devices, or the functions of two or more “blocks” or devices may be implemented by one physical device.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram of the configuration of an information processing system according to an embodiment;

FIG. 2 is a diagram of the hardware configuration of a mobile terminal;

FIG. 3 is a diagram of functional blocks in the mobile terminal;

FIG. 4 is a diagram of the hardware configuration of an Internet banking system;

FIG. 5 is a diagram of functional blocks in the Internet banking system;

FIG. 6A is a diagram of a screen for entering a transfer request on the mobile terminal;

FIG. 6B is a diagram of a screen for entering a financial institution of a transfer account;

FIG. 6C is a diagram of a screen after a financial institution is entered;

FIG. 6D is a diagram of a screen after the financial institution is entered;

FIG. 7A is a diagram of a known screen for entering a transfer request in a general Internet banking system;

FIG. 7B is a diagram of a known screen for entering a financial institution of a transfer account; and

FIG. 7C is a diagram of a known screen after a financial institution is entered.

### DETAILED DESCRIPTION

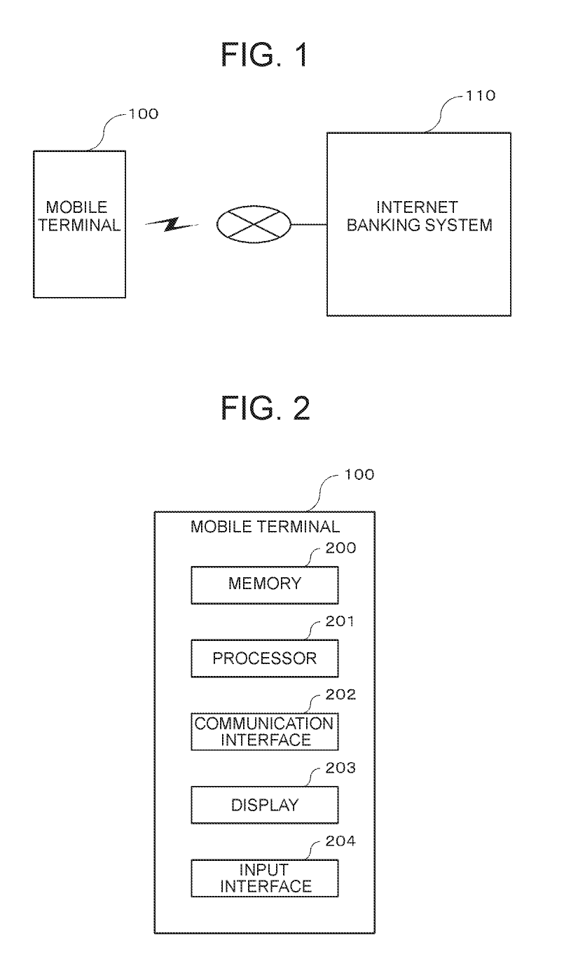

FIG. 1 is a diagram illustrating the configuration of an information processing system according to an embodiment. The information processing system includes a mobile terminal 100 and an Internet banking system 110.

The mobile terminal 100 is, for example, a portable computer, such as a smartphone or a tablet terminal. For example, the mobile terminal 100 can access the Internet through a radio communication network for cellular phones or a wireless LAN (Local Area Network). In the embodiment, the mobile terminal 100 can access the Internet banking system 110. Although only one mobile terminal 100 is illustrated in FIG. 1, there exist many mobile terminals 100 that use the Internet banking system 110.

The Internet banking system 110 is a system for providing various financial services via the Internet, such as balance inquiry and transfer. For example, the Internet banking system 110 includes one or more computers. The Internet banking system 110 can also provide services to the mobile terminal 100 in cooperation with other systems, such as a billing system and a database system.

FIG. 2 is a diagram illustrating an example of the hardware configuration of the mobile terminal 100. As illustrated in FIG. 2, the mobile terminal 100 includes a memory 200, a processor 201, a communication interface 202, a display 203, and an input interface 204.

The memory 200 is a storage area for storing data and programs. The data and programs may be stored in the memory 200 permanently or temporarily. For example, a web browser program as an application used to access the Internet banking system 110 is stored in the memory 200. Further, HTML (HyperText Markup Language) files, style sheets, and the like, used by a web browser to provide a screen display during accessing the Internet banking system 110 using the web browser, are stored in the memory 200. The HTML files and the like used by application programs are also programs for controlling the operation of the mobile terminal 100.

The processor 201 executes programs stored in the memory 200 to implement various functions of the mobile terminal 100. For example, the processor 201 executes the web browser program stored in the memory 200 to implement various functions for using the Internet banking system 110.

The communication interface 202 is an interface for exchanging data with the outside of the mobile terminal 100. For example, the communication interface 202 includes an interface for accessing the radio communication network for cellular phones, an interface for accessing the wireless LAN, and the like. For example, the communication interface 202 may also include an interface for a wired network, such as USB (Universal Serial Bus).

The display 203 is a device for displaying a variety of information, which is, for example, a liquid crystal display or an organic EL (Electroluminescence) display.

The input interface 204 is a device for accepting input from a user. For example, the input interface 204 includes a touch panel provided on the display 203, various input keys, and the like.

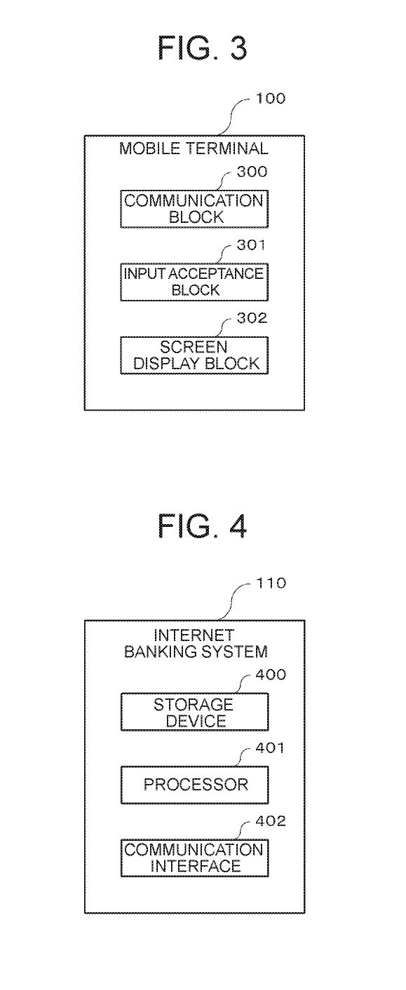

FIG. 3 is a diagram illustrating an example of functional blocks in the mobile terminal 100. The functions illustrated in FIG. 3 are some functions used to use the Internet banking system 110, and not all the functions of the mobile terminal 100. As illustrated in FIG. 3, the mobile terminal 100 includes a communication block 300, an input acceptance block 301, and a screen display block 302. For example, each of these blocks is implemented by the processor 201 executing a program stored in the memory 200.

The communication block 300 exchanges data and programs with the Internet banking system 110. For example, the communication block 300 transmits an acquisition request for data and programs to the Internet banking system 110 so that an HTML file, an XML (Extensible Markup Language) file, a style sheet, image data, and the like can be received from the Internet banking system 110 according to the acquisition request. The data and programs received from the Internet banking system 110 are stored in the memory 200.

The input acceptance block 301 accepts various pieces of user input when the user uses the Internet banking system 110. For example, the input acceptance block 301 can accept input of a user ID and a password, and input for specifying a transfer account.

The screen display block 302 displays, on the display 203, various screens for using the Internet banking system 110 based on the HTML file and the like received from the Internet banking system 110.

FIG. 4 is a diagram illustrating an example of the hardware configuration of the Internet banking system 110. As illustrated in FIG. 4, the Internet banking system 110 includes a storage device 400, a processor 401, and a communication interface 402.

The storage device 400 is a storage area such as a memory or a hard disk drive. Data and programs for implementing the Internet banking system 110 are stored in the storage device 400. For example, programs for implementing various functions of the Internet banking system 110, HTML files for displaying screens on the mobile terminal 100 to use the Internet banking system 110, account data for user authentication, various types of data necessary to perform bank transactions, and the like are stored in the storage device 400.

There is no need to pre-store, in the storage device 400, all pieces of data and programs used in the Internet banking system 110. Some pieces of data and programs may be acquired from outside through the communication interface 402 as needed and stored in the storage device 400.

The processor 401 executes programs stored in the storage device 400 to implement various functions in the Internet banking system 110.

The communication interface 402 is an interface for exchanging data with the outside of the Internet banking system 110. For example, the communication interface 402 can include an interface such as Ethernet (registered trademark).

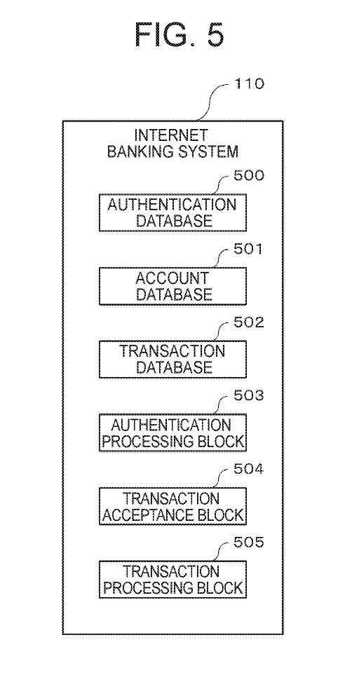

FIG. 5 is a diagram illustrating an example of functional blocks in the Internet banking system 110. As illustrated in FIG. 5, the Internet banking system 110 includes an authentication database 500, an account database 501, a transaction database 502, an authentication processing block 503, a transaction acceptance block 504, and a transaction processing block 505. Each of these blocks is, for example, implemented by the processor 401 executing a program stored in the storage device 400.

The authentication database 500 stores account data, such as a user ID, a password, PIN, and the like used to use the Internet banking system 110.

The account database 501 stores account data indicative of information on each account, such as account number, account holder, and account balance.

The transaction database 502 stores transaction data necessary to conduct a transaction requested from a user in the Internet banking system 110. For example, in the case of a transfer, transaction data indicative of the settlement account, the transfer account, the transfer amount, and the like are stored in the transaction database 502.

The authentication processing block 503 performs authentication processing based on the account data stored in the authentication database 500. The authentication processing is performed, for example, at the time of logging in to the Internet banking system 110, at the time of executing a transfer process, and the like.

The transaction acceptance block 504 accepts a transaction request from the user. Transactions accepted by the transaction acceptance block 504 include inquiry transactions without data updating and update transactions with data updating. For example, the inquiry transactions include a balance inquiry and an account activity inquiry. Further, for example, the update transactions include wire transfer and account transfer. When accepting a request for an update transaction, the transaction acceptance block 504 stores, in the transaction database 502, transaction data necessary to conduct the transaction.

Based on the transaction data stored in the transaction database 502, the transaction processing block 505 conducts the transaction requested from the user. For example, based on the transaction data, the transaction processing block 505 updates the account database 501, or generates data to be output to another system. The other system is, for example, a batch processing system in the same bank, a system of another bank connected through an interbank network, or the like.

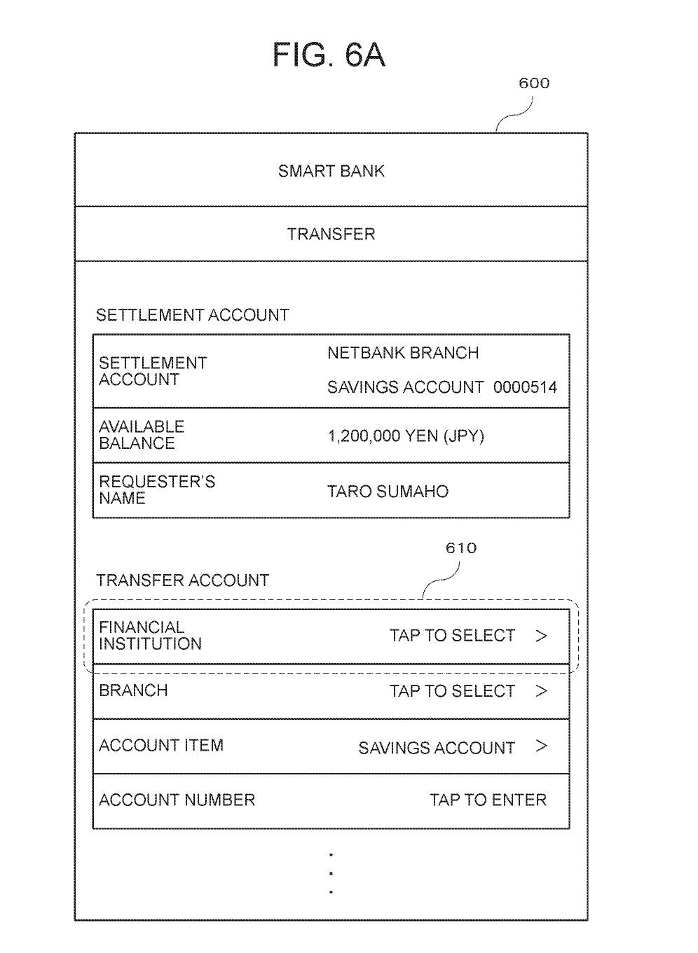

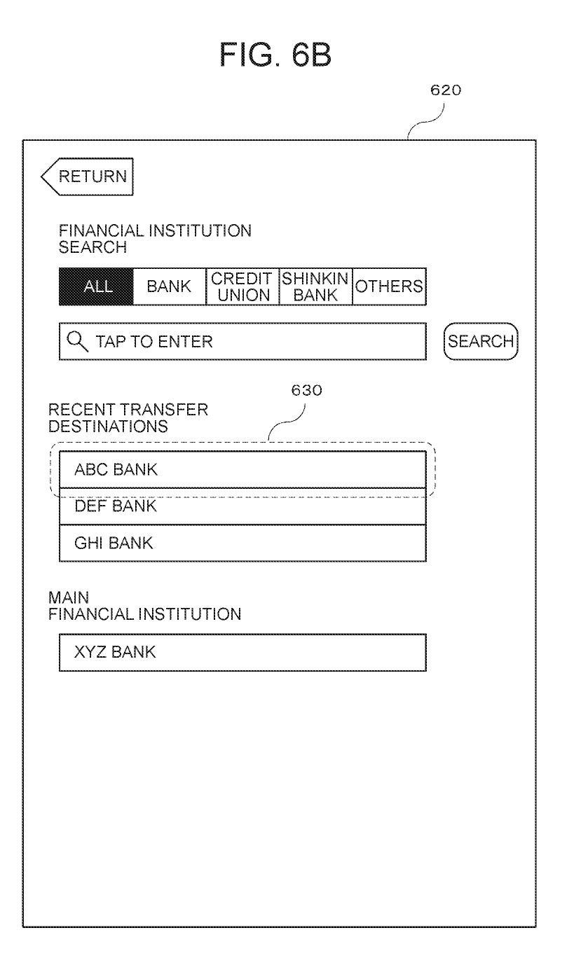

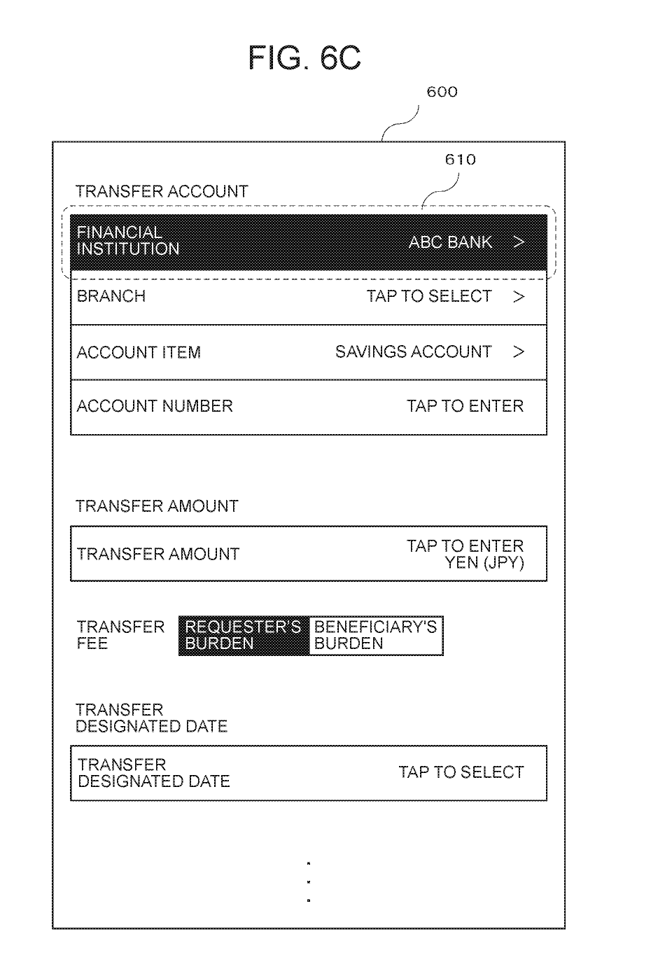

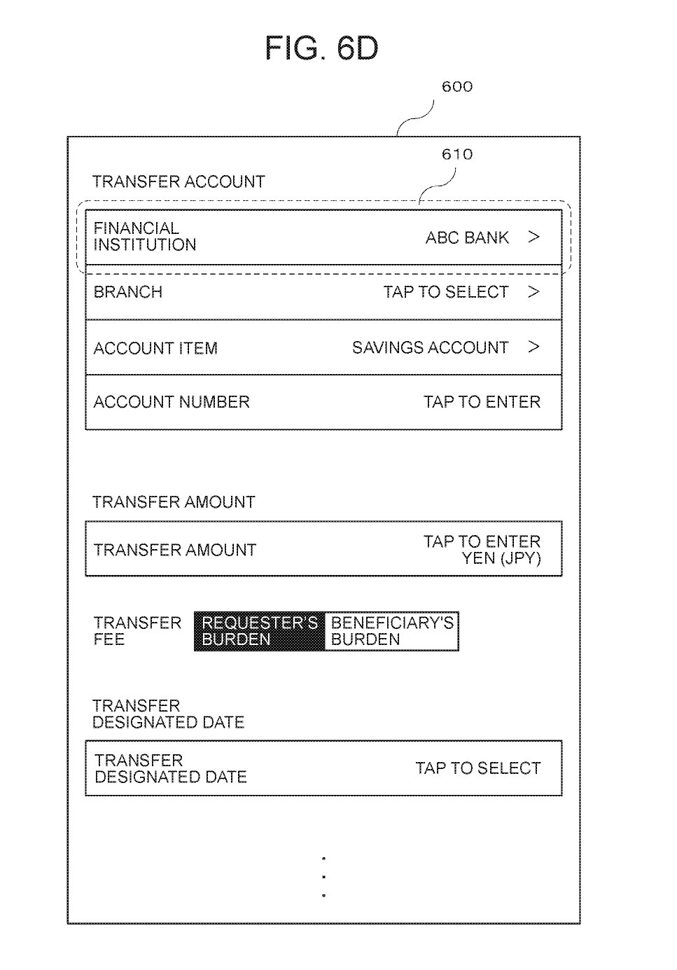

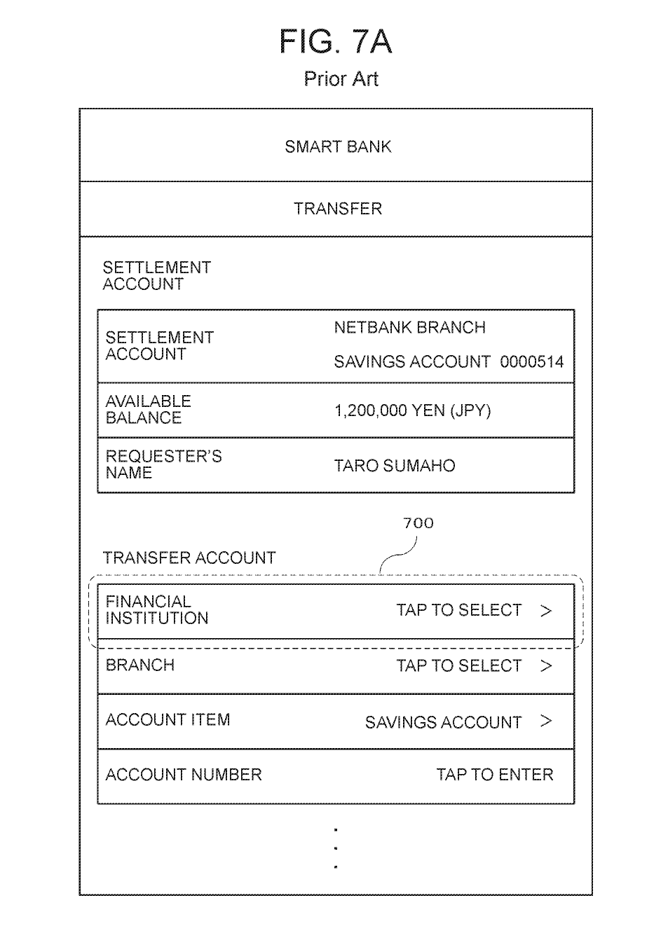

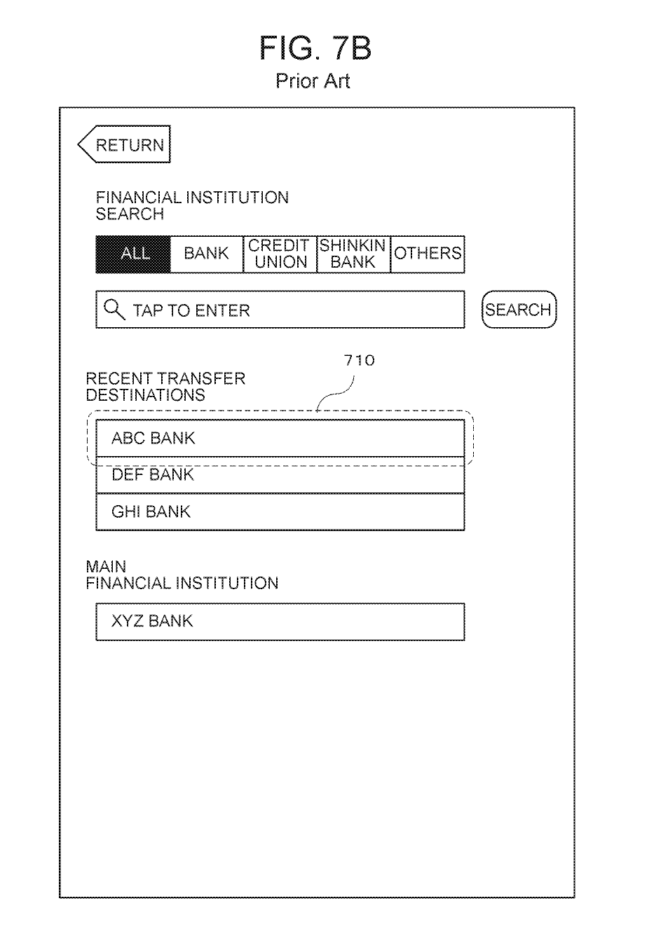

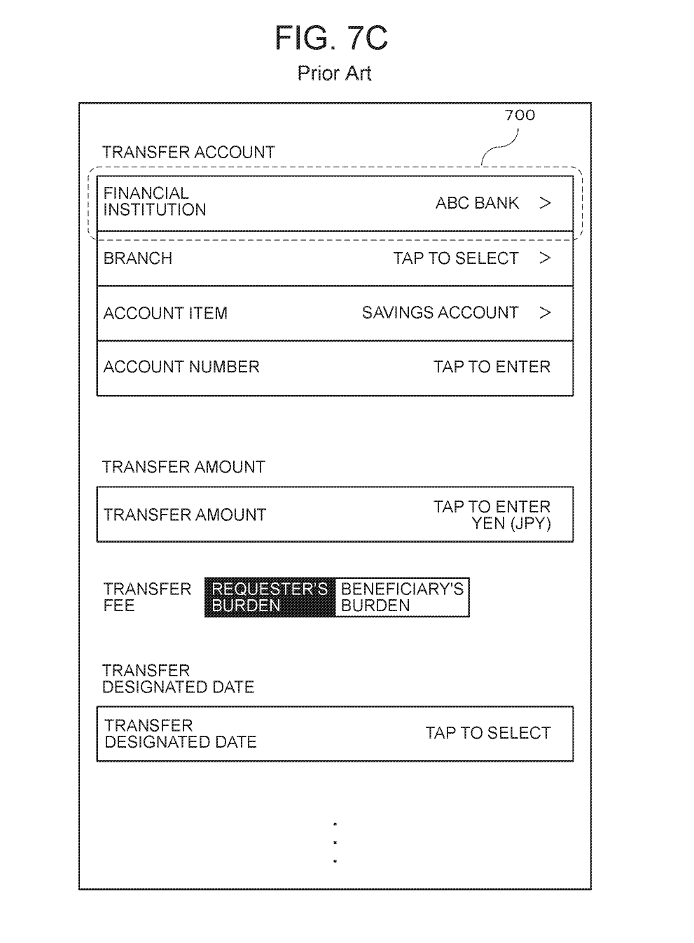

Referring to FIGS. 6A through FIG. 6D, an example of screen control in the Internet banking system 110 is described. FIG. 6A is a diagram illustrating an example of a screen for entering a transfer request on the mobile terminal 100. A screen 600 is displayed, for example, by selecting transfer from a transaction menu after logging in to the Internet banking system 110. Specifically, when accepting the selection of transfer, the input acceptance block 301 of the mobile terminal 100 transmits, to the Internet banking system 110, an output request for the screen 600. The transaction acceptance block 504 of the Internet banking system 110 transmits, to the mobile terminal 100, an HTML file and the like for displaying the screen 600 in response to the request. Based on the HTML file and the like received from the Internet banking system 110, the screen display block 302 of the mobile terminal 100 displays the screen 600 (first screen) on the display 203 of the mobile terminal 100 (initial screen display procedure). For example, the screen display block 302 can scroll the screen 600 up and down in response to an operation on a touch panel or of input keys.

As illustrated in FIG. 6A, the screen 600 contains a display area 610 for specifying a financial institution (first item) of a transfer account. In FIG. 6A, the display area 610 is displayed in the same display mode (first display mode) as the other items.

When the display area 610 is selected, the screen display block 302 transmits, to the Internet banking system 110, an output request for a screen according to the display area 610. In response to the request, the transaction acceptance block 504 of the Internet banking system 110 transmits, to the mobile terminal 100, an HTML file and the like to display a screen for entering the financial institution of the transfer account.

Based on the HTML file and the like received from the Internet banking system 110, the screen display block 302 of the mobile terminal 100 displays a screen 620 (second screen) on the display 203 of the mobile terminal 100 as illustrated in FIG. 6B (input screen display procedure).

On the screen 620, the financial institution can be searched for or selected from recent transfer destinations to input the financial institution of the transfer account. For example, on the screen 620, the user can select a display area 630 in which “ABC bank” is displayed as one of the recent transfer destinations to enter “ABC bank” as the financial institution of the transfer account.

When the financial institution is input on the screen 620, the screen display block 302 displays, on the display 203 of the mobile terminal 100, the screen 600 (first screen) with the input financial institution displayed in the display area 610 as illustrated in FIG. 6C (initial screen update procedure). As illustrated in FIG. 6C, when the financial institution is input, the screen display block 302 displays the display area 610 in a position further up than that before the financial institution is input (near the uppermost part in FIG. 6C). Thus, since the input item is displayed in the upper part of the screen, an item (e.g., branch) to be input next is displayed in the upper part of the screen, and this can make it easy for the user to perform input.

However, if the display position of the item is changed before and after the input of the item on the screen 600, the user may lose the place where the user has operated. Therefore, in this embodiment, the screen display block 302 displays the display area 610 in a display mode (second display mode) different from other items as illustrated in FIG. 6C. For example, the screen display block 302 can display the display area 610 in a color or font different from the other items. After that, as illustrated in FIG. 6D, the screen display block 302 can return the display mode of the display area 610 to the previous mode (first display mode) after the lapse of a predetermined time. Thus, the display mode can be changed to make it easy for the user to find the place where the user has operated.

The screen display block 302 can make a change to the previous display mode (e.g., a change from FIG. 6C to FIG. 6D) in a step-by-step manner. For example, the screen display block 302 can change the color of the display area 610 in a step-by-step manner.

According to this embodiment, when the financial institution (first item) of the transfer account is selected on the screen 600 (FIG. 6A: first screen) for transfer input, the screen 620 (FIG. 6B: second screen) for inputting a financial institution is displayed. Then, when a financial institution is input, the screen 600 (FIG. 6C: first screen) is displayed in a state where the input financial institution is displayed. At this time, the display mode of the display area 610 for the financial institution is changed before and after the input of the financial institution. This can draw user's attention to the display area 610, the display mode of which is changed, to make it easy for the user to find the place where the user has operated.

Further, according to this embodiment, the display mode can be returned from the state (FIG. 6C), where the display mode of the display area 610 for the financial institution is changed, to the previous state (FIG. 6D). This can make the display area 610 more conspicuous to make it easy for the user to find the place where the user has operated.

Further, according to this embodiment, when the display mode is returned to the previous state (FIG. 6D), the display mode can be changed in a step-by-step manner. This can make the display area 610 more conspicuous to make it easy for the user to find the place where the user has operated.

In this embodiment, the display area 610 is displayed in different display positions before and after the input of the financial institution. In such a case, the user is more likely to lose the place where the user has operated. Therefore, the effect due to the change in the display mode of the display area 610 for the financial institution before and after the input of the financial institution like in this embodiment becomes large.

Note that this embodiment is to facilitate the understanding of the disclosure, and is not to limit the interpretation of the various embodiments. The various embodiments can be modified and improved without departing from the spirit of the disclosure, and equivalents thereof are included in the disclosure.

For example, in this embodiment, the transfer screen 600 in the Internet banking system 110 has been described as an example, but the target screen is not limited thereto. For example, it may be any other screen in the Internet banking system 110, or may be a screen in an entirely different system.

In various embodiments according to the present disclosure, including those discussed above, functionalities of the data computation units and/or blocks may be implemented in the form of at least one hardware processor configured to carry out these functionalities. That is, the performance of any one or more of the functionalities may be accomplished by a single hardware processor, or be divided, in any manner known to those skilled in the art, among multiple hardware processors.

The various embodiments have been described in detail with particular reference and examples, but it will be understood that variations and modifications can be effected within the spirit and scope of the various embodiments covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

What is claimed is:

1. A non-transitory computer-readable storage medium storing a screen display program for causing a mobile terminal to execute:
an initial screen display procedure that includes displaying a first screen including a first item displayed in a first display mode;
an input screen display procedure that includes displaying a second screen configured to receive an input of a value of the first item when the first item is selected on the first screen; and
an initial screen update procedure that includes displaying an updated first screen including the first item displayed in a second display mode along with the value of the first item when the value of the first item is input on the second screen.

2. The storage medium according to claim 1, wherein the first item is a financial institution as a transaction target in an Internet banking system.

3. The non-transitory computer-readable storage medium according to claim 1, wherein the initial screen update procedure includes displaying the first item in the first display mode after the first item has been displayed in the second display mode on the updated first screen for a predetermined period of time.

4. The storage medium according to claim 3, wherein the first item is a financial institution as a transaction target in an Internet banking system.

5. The non-transitory computer-readable storage medium according to claim 3, wherein the initial screen update procedure includes changing the first item from being displayed in the second display mode to the first display mode in a step-by-step manner.

6. The storage medium according to claim 5, wherein the first item is a financial institution as a transaction target in an Internet banking system.

7. The non-transitory computer-readable storage medium according to claim 5, wherein the initial screen update procedure includes displaying the first item on the updated first screen in a different position than a position in which the first item was displayed on the first screen.

8. The non-transitory computer-readable storage medium according to claim 7, wherein the first item is a financial institution as a transaction target in an Internet banking system.

9. The non-transitory computer-readable storage medium according to claim 7, wherein the initial screen update procedure includes displaying the first item on the updated first screen in a position higher than the position in which the first item was displayed on the first screen.

10. The non-transitory computer-readable storage medium according to claim 9, wherein the first item is a financial institution as a transaction target in an Internet banking system.

11. The non-transitory computer-readable storage medium according to claim 3, wherein the initial screen update procedure includes displaying the first item on the updated first screen in a different position than a position in which the first item was displayed on the first screen.

12. The non-transitory computer-readable storage medium according to claim 11, wherein the first item is a financial institution as a transaction target in an Internet banking system.

13. The non-transitory computer-readable storage medium according to claim 11, wherein the initial screen update procedure includes displaying the first item on the updated first screen in a position higher than the position in which the first item was displayed on the first screen.

14. The non-transitory computer-readable storage medium according to claim 13, wherein the first item is a financial institution as a transaction target in an Internet banking system.

15. A method, comprising:
in a mobile terminal with a touch screen display,
displaying a first screen including a first item displayed in a first display mode;
displaying a second screen configured to receive an input of a value of the first item when the first item is selected on the first screen; and
displaying an updated first screen including the first item displayed in a second display mode along with the value of the first item when the value of the first item is input on the second screen.

16. The method according to claim 15, further comprising displaying the first item in the first display mode after the first item has been displayed in the second display mode on the updated first screen for a predetermined period of time.

17. The method according to claim 16, further comprising changing the first item from being displayed in the second display mode to the first display mode in a step-by-step manner.

18. The method according to claim 15, further comprising displaying the first item on the updated first screen in a different position than a position in which the first item was displayed on the first screen.

19. The method according to claim 18, further comprising displaying the first item on the updated first screen in a position higher than the position in which the first item was displayed on the first screen.

20. The method according to claim 15, wherein the first item is a financial institution as a transaction target in an Internet banking system.
